(19) United States
(12) Patent Application Publication
(10) Pub. No.: US 2006/0130377 A1
(43) Pub. Date: Jun. 22, 2006

(54) Vibratile lamp with lustrous foil fragment

(76) Inventor: Ming-Kuei Lin, Taipei Hsien (TW)

Correspondence Address: DAVID E. DOUGHERTY;Dennison, Schultz, Dougherty & Macdonald, Suite 105, 1727 King Street, Alexandria, VA, 22314-2700, US

(21) Appl. No.: 11/014,864

(22) Filed: Dec. 20, 2004

(51) Int. Cl. G09F 19/00

(52) U.S. Cl. 40/407; 428/98; 40/406

(57) ABSTRACT

A vibratile lamp with lustrous foil fragments includes a transparent container, a base and a cover. The transparent container with a clear liquid and a plurality of colored lustrous foil fragments therein is fixed on top of the base for displaying while a circuit board, a battery holder, a vibration switch and a plurality of LED light facing the bottom of the transparent container are arranged inside the base. By shaking the vibratile lamp with lustrous foil fragments, the colored lustrous foil fragments inside the transparent container flow upwards and downwards for a period of time. At the same time, the LED lights illuminate by the control of the vibration switch and light emits toward the transparent container so as to have colorful, bright and glittering dynamic display effect as well as electricity-saving and safety purposes.

### BACKGROUND OF THE INVENTION

The present invention relates to a vibratile lamp with lustrous foil fragments, especially to a lamp by vibration to make a plurality of differently colored lustrous foil fragments therein flow upwards and downwards and by a vibration switch to make the LED light illuminate a transparent container so as to achieve colorful, bright and glittering dynamic display effect. Thus the present invention replaces traditional light bulbs that produce light and heat to have electricity saving and safe working effect.

Refer to U.S. Pat. No. 6,309,084 B1 [symbol] LAMP SHOWING DYNAMICALLY CHANGEFUL LUSTER AND SHADOW [symbol] applied by the same inventor of the present invention, a conventional lamp with floating and lustrous foil fragments is shown in FIG. 1. The conventional lamp with floating and lustrous foil fragments consists of a light bulb generating heat and a transparent container with a low-boiling-point clear liquid and a plurality of colored lustrous foil fragments therein. The liquid is heated by the heat from the light bulb to generate convective currents for driving lustrous foil fragments upwards and downward. Thus a dynamic display effect is achieved. However, the conventional lamp with floating and lustrous foil fragments consume more electricity thus is not suitable to use batteries. Most of them are connected with indoor power sources and need a certain space to be arranged. Therefore, them can not be disposed according to users' favors such as on desks in offices or in cars. There are limits on sites being used.

### SUMMARY OF THE INVENTION

Therefore it is a primary object of the present invention to provide a vibratile lamp with lustrous foil fragments that uses a transparent container with a clear liquid and a plurality of differently colored lustrous foil fragments therein fixed on top of a base. And a circuit board, a battery holder, a vibration switch and a plurality of LED light are arranged inside the base. By shaking the vibratile lamp with lustrous foil fragments, the colored lustrous foil fragments inside the transparent container flow upwards and downwards and the LED lights emit towards the transparent container by a vibration switch. Thus the transparent container achieves colorful, bright and glittering dynamic display effect. The present invention replaces conventional light bulbs that generate heat and achieves electricity-saving and safety purposes.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment in accordance with the present invention;

FIG. 2 is an explosive view of the embodiment shown in FIG. 1;

FIG. 3 is a cross-sectional view of an embodiment in accordance with the present invention;

FIG. 4 is a schematic drawing of the embodiment of the present invention being used.

### DETAILED DESCRIPTION OF THE PREFFERED EMBODIMENT

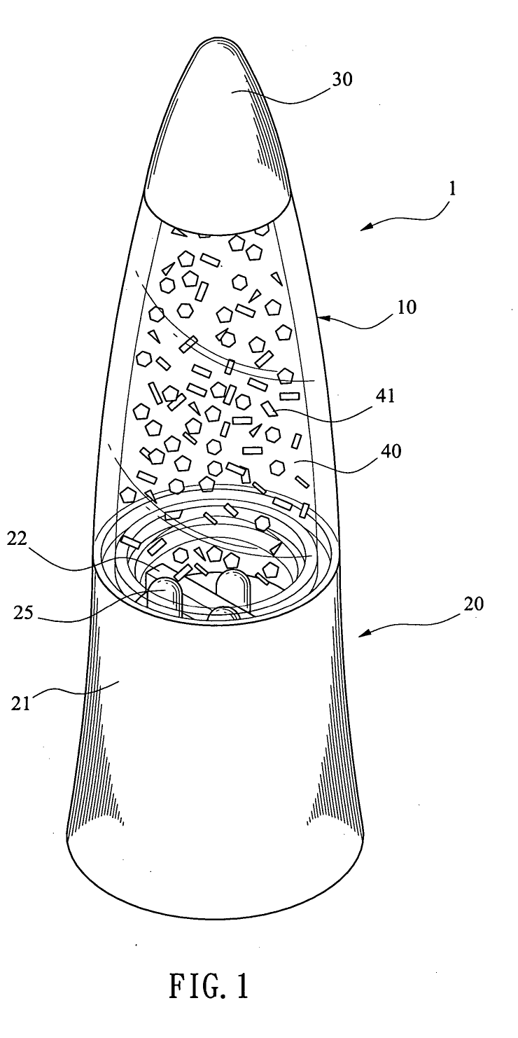

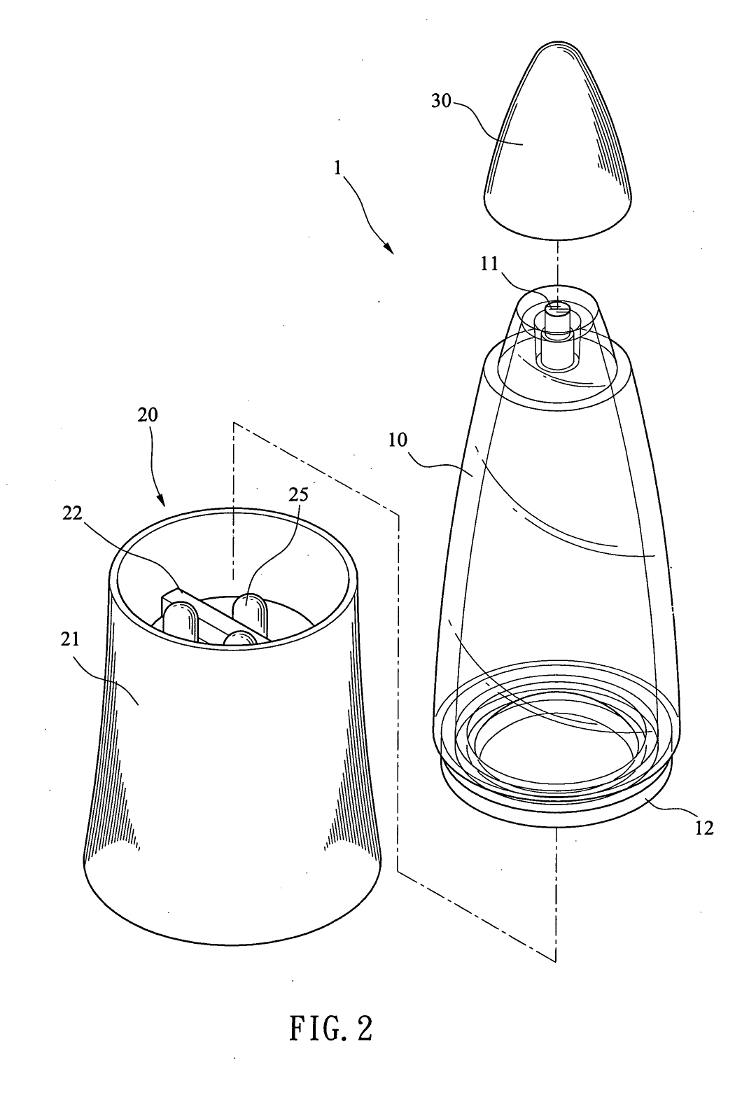

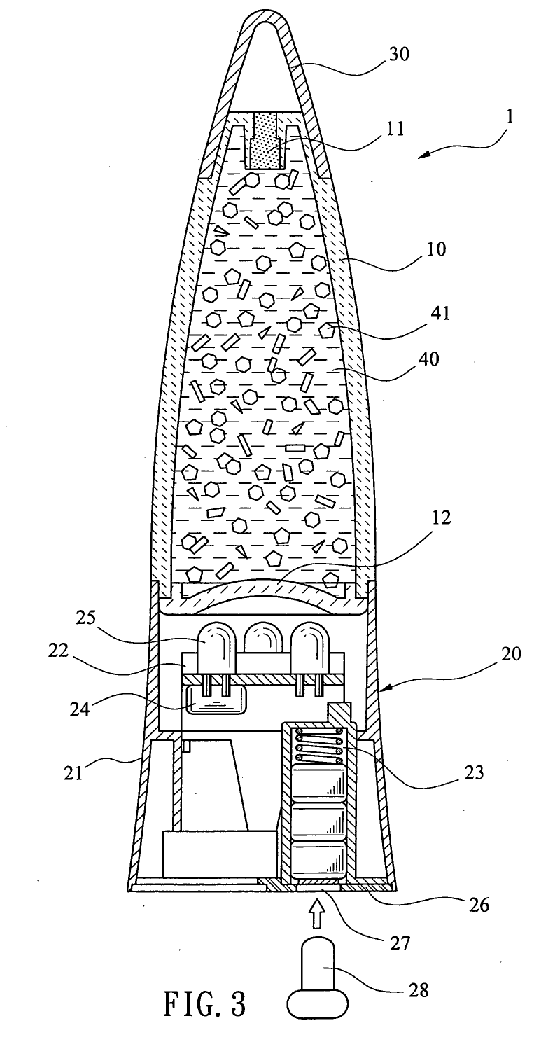

Refer to FIG. 1, FIG. 2 & FIG. 3, a vibratile lamp with lustrous foil fragments 1 in accordance with the present invention consists of a transparent container 10, a base 20 and a cover 30. The transparent container 10 made of glass or heat-resistant plastic is smaller than traditional lamps with lustrous foil fragments on desks and is disposed on top of the base 20. A clear liquid 40 with a plurality of differently colored lustrous foil fragments 41 therein is filled inside the transparent container 10 and a stopper 11 is sealed on top of the transparent container 10. The base having a shell 21, a circuit board 22, a battery holder 23, a vibration switch 24 and a plurality of LED light 25 emitting towards the bottom 12 of the transparent container 10 is put on a desk. The battery holder 23 is for mercury battery. There is no limits on number and color of the LED light 25 and the arrangement of the LED light 25 is varied according to the design of circuit board 22. For example, at least one LED light 25 or a plurality of LED lights 25 with different colors is/are arranged on the same or different positions on the circuit board 22, and the lighting pattern can be set in general or cross. Or the period of luminance of the LED light 25 is from one to three minutes and then stops automatically in accordance with the flowing of the lustrous foil fragments 41. And the vibration switch 24 is a conventional technique and is designed depending on the circuit board 22.

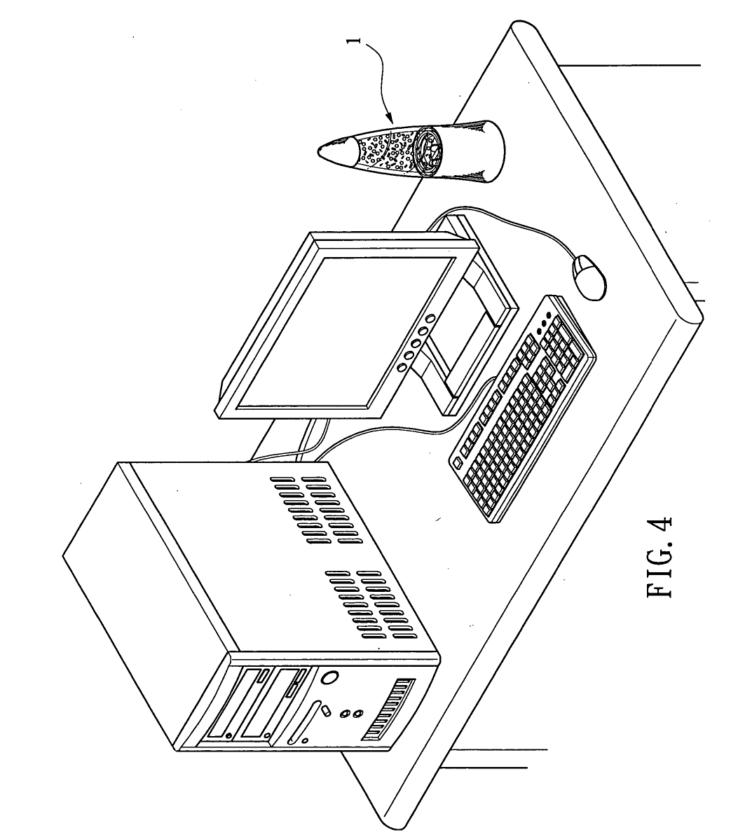

In usage, the sites of arranging the vibratile lamp with lustrous foil fragments 1 depend on users favors, such as on a desk in office, as shown in FIG. 4 or in car. Users only need to shake the vibratile lamp with lustrous foil fragments 1, the lustrous foil fragments 41 inside the transparent container 10 flows upwards and downwards. At the same time, the LED lights 25 illuminate by the vibration switch 24 and light from the LED lights 25 emits toward the bottom 12 of the transparent container 10. Thus the transparent container 10 has colorful, bright and glittering dynamic display effect. Moreover, the LED lights 25 is electricity-saving and without generating heat, compared with traditional light bulbs so as to achieve electricity-saving and safety purposes.

As to the lustrous foil fragments 41 available right now, they are quite light so that when the transparent container 10 is shaken, the lustrous foil fragments 41 keep flowing upwards and downwards for a period of time and then turn back to static status. In other words, after users shaking the transparent container 10 directly, the lustrous foil fragments 41 keep flowing upwards and downwards for about 1 to 3 minutes for visual effect. There is no need to use light bulb as a heat source thus it's more safe and electricity-saving.

Furthermore, when being unused, the vibration switch 24 should not be initiated to activate the vibratile lamp with lustrous foil fragments 1. Thus refer to FIG. 3, an insertion slot 27 is mounted on a bottom cap 26 of the shell 21, corresponding to the position of the battery holder 23, and an insulated plastic sheet 28 is inserted into the insertion slot 27 to be located in a connecting point of the battery holder 23, such as a point between the two batteries or between one battery and a conductive film in the battery holder 23 for achieving power-off condition. When the device is not used, such as during transportation or demonstration for sales, the plastic sheet 28 is inserted into the insertion slot 27 so as to avoid the vibration switch 24 being activated and consuming electricity. When being used, just remove the plastic sheet 28 and the device turns back into power-on condition.

What is claimed is:

1. A vibratile lamp with lustrous foil fragments comprising a transparent container, a base and a cover; wherein the transparent container is made of glass or heat-resistant plastic with a stopper sealed on top thereof and is fixed on top of the base; a clear liquid and a plurality of colored lustrous foil fragments is filled inside the transparent container;
the base having a shell outside, a circuit board, a battery holder, a vibration switch and a plurality of LED light emitting towards the bottom of the transparent container inside is put on a desk; and the LED lights illuminate when the vibration switch is activated;
the cover for protecting the top of the transparent container and the stopper;
in accordance with above structure, the colored lustrous foil fragments flows upwards and downwards inside the transparent container by shaking the vibratile lamp with lustrous foil fragments and by shaking, the vibration switch activate the LED lights to illuminate and light emits through the bottom of the transparent container so as to make the colored lustrous foil fragments have colorful, bright and glittering dynamic display effect inside the transparent container.

2. The vibratile lamp with lustrous foil fragments as claimed in claim 1, wherein the LED lights have various colors and numbers.

3. The vibratile lamp with lustrous foil fragments as claimed in claim 1, wherein the LED lights have cross lighting pattern.

4. The vibratile lamp with lustrous foil fragments as claimed in claim 2, wherein the LED lights have cross lighting pattern.

5. The vibratile lamp with lustrous foil fragments as claimed in claim 1, wherein the LED lights illuminate for a period of time and then stop automatically.

6. The vibratile lamp with lustrous foil fragments as claimed in claim 2, wherein the LED lights illuminate for a period of time and then stop automatically.

7. The vibratile lamp with lustrous foil fragments as claimed in claim 1, wherein an insertion slot is mounted on the shell, corresponding to the position of the battery holder, and an insulated plastic sheet is inserted into the insertion slot and is inside the battery holder for achieving power-off condition so as to inactivate the vibration switch.

8. The vibratile lamp with lustrous foil fragments as claimed in claim 7, wherein the plastic sheet is inserted into the insertion slot and is between two batteries or between one battery and a conductive film in the battery holder.
